(19) United States
(12) Patent Application Publication
(10) Pub. No.: US 2010/0283533 A1
(43) Pub. Date: Nov. 11, 2010

(54) Charge pump circuit and method

(75) Inventor: Bo Li, Folsom, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Numonyx BV

(21) Appl. No.: 12/387,655

(22) Filed: May 5, 2009

(51) Int. Cl. G05F 1/10

(52) U.S. Cl. 327/536

(57) ABSTRACT

A charge pump circuit and its method of operation are described. Switching devices in each stage alternately charge one of a first and second nodes while the other of the nodes is discharged. A boosting circuit boosts the potential on the one of the first and second nodes being discharged. The first node in a stage (n) is discharged into a first node in a stage (n+1). In one embodiment, a triple-well, tri-channel pipeline charge pump is described.

### FIELD OF THE INVENTION

Embodiments of the invention relates to the field of high voltage generators, in particular, the on-chip generation of a higher voltage than a supply voltage for an integrated circuit.

### PRIOR ART AND RELATED ART

Integrated circuits sometimes have on-chip circuits to generate higher potentials than their supply potentials. In some cases, capacitors are charged in parallel, and then connected in series to provide the higher potential. In other cases, a potential on a capacitor or node is boosted by, for example, a clock signal.

One early example of an integrated circuit which relied on external capacitors to provide a tripling of voltage for a liquid crystal display in a watch is shown in U.S. Pat. No. 3,975,671. Another example where both two-phase and four-phase clock signals are used with a special n-type devices having a low threshold voltage is shown in U.S. Pat. No. 5,422,586. Other examples of prior art using special n-channel devices are shown in U.S. Pat. Nos. 6,496,055; 6,686,793; and 7,342,438.

One goal in designing a charge pump circuits is to reduce the substrate area needed for the circuit. This is particularly important where the circuit provides the higher programming and erasing potentials in a flash memory since the saved substrate area allows for the fabrication of additional memory cells. Another goal is to increase the efficiency of the charge pump circuit, this of course becomes more important when the integrated circuit is powered from a battery.

### BRIEF DESCRIPTION OF THE DRAWINGS

FIG. 1A is a simplified circuit diagram illustrating the operation of the circuit of FIG. 3 for one state of clock signals.

FIG. 1B is a simplified circuit diagram illustrating the operation of the circuit of FIG. 3 during the other state of the clock signals.

FIG. 2 is a block diagram illustrating an embodiment of the charge pump circuit along with the clock signals used in its operation.

FIG. 3 is a schematic drawing of one stage of the charge pump circuit of FIG. 2.

FIG. 4 is a cross-sectional, elevation view of a substrate illustrating an n-channel device used in the circuit of FIG. 3.

FIG. 5 is a cross-sectional, elevation view of a substrate illustrating an n-well with a plurality of p-channel devices formed therein, used in the circuit of FIG. 3.

### DETAILED DESCRIPTION

A charge pump circuit and its method of operation are described. In one embodiment, a triple-well, tri-channel pipe-line charge pump circuit for providing a positive potential is described. In the following description, numerous specific details are set forth such as specific conductivity types, in order to provide a thorough understanding of the present invention. It will be apparent to one skilled in the art, that the embodiments of the present invention may be practiced without these specific details. In other instances, details such as fabrication details are not set forth, in order not to unnecessarily obscure the present invention.

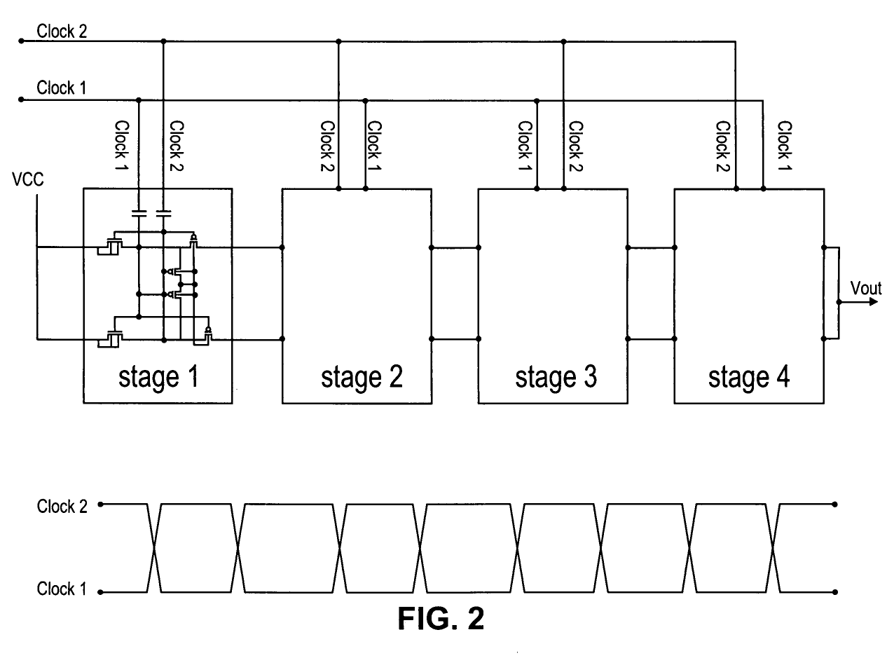

Referring briefly first to FIG. 2, the illustrated embodiment of the charge pump includes four stages, although the precise number of stages is not critical, as will be apparent. Stage 1 receives the potential V_{cc}, which is boosted and provides the input to stage 2. Each stage boosts its input potential, with stage 4 providing the output (Vout). The stages receive complementary clock signals shown in FIG. 2, specifically clock 1 and its complement, clock 2. In one embodiment, the clock signals have a frequency of 300 MHz. Both clock signals are coupled to each of the stages form stage-to-stage, however, as will be discussed, the connection of the clock signals is reversed. The clock signals are applied to the stages through capacitors shown in stage 1 of FIG. 2 to provide boot strapping of nodes within the stage.

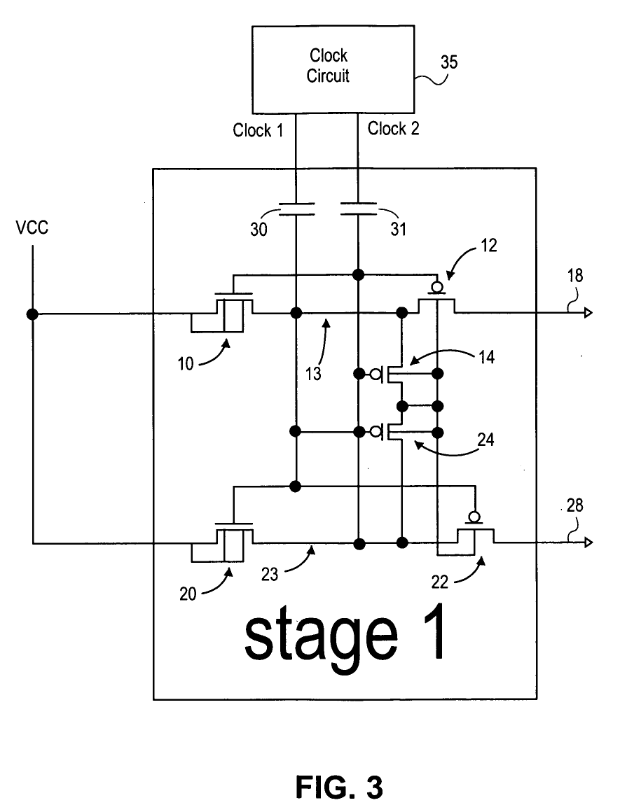

Referring to FIG. 3, stage 1 includes a first leg comprising n-channel device 10, node 13, and p-channel device 12; and a second leg comprising the n-channel device 20, node 23, and p-channel device 22. Nodes 13 and 23 are alternately charge and discharged and thus are sometimes referred to below as charge nodes. The n-channel devices 10 and 20 are input devices in that they control the input of charge to the nodes 13 and 23, respectively. The p-channel devices 12 and 22 are referred to as output devices since they control the discharging of the nodes 13 and 23, respectively, and allow charge to flow onto the output lines 18 and 28 and into the next stage, or to a common line in the final stage.

P-channel transistors 14 and 24 are alternately turned on, as will be seen, to boost the potential of the well for the output devices 12 and 22, thereby reducing the threshold voltage drop as these output devices transfer charge from their respective nodes to the output lines.

The gates of the devices 10 and 12 are coupled to receive the clock 2 signal through the capacitor 31. Similarly, the gates of the devices 20 and 22 are coupled to receive the clock 1 signal through the capacitor 30. Node 13 is coupled to the capacitor 30, and thus receives clock 1, and likewise, node 23 is coupled to capacitor 31 and receives clock 2. The clock 1 signal is also coupled to the gate of the transistor 24, and likewise, the clock 2 signal is coupled to the gate of the transistor 14.

The other stages have the same circuit as shown for stage 1 except for the clock connection. In the even-numbered stages, stages 2 and 4 of FIG. 3, the clock 1 and 2 signals are interchanged. Thus, the clock I signal is coupled to the gates of the input and output devices in the first leg and to the charge node in the second leg, and the clock 2 signal is coupled to the gates of the input and output devices in the second leg and to the charge node of the first leg. The output devices of one stage such as devices 12 and 22, are coupled to the input devices in the subsequent stage. Thus, line 18 is connected to an n-channel device in the first leg of the next stage, and similarly line 28 is coupled to the input device of the second leg of the next stage. The input devices in the first stage both receive the potential V_{cc}. The output lines of the last stage may be coupled together, as shown at the output of stage 4 of FIG. 2, to provide the final output potential.

It should be noted that reversing the clocking signals between stages is the same as keeping the same clocking signal connection for all stages and reversing the connection of the legs between stages. For instance, the output from the first leg of stage 1 may then be connected to the input to the second leg of stage 2, and the output of the second leg of stage 1 may be connected to the input of the first leg of stage 2. This is just a matter of how one numbers the legs in consecutive stages.

The clock circuit 35 of FIG. 3, in one embodiment, is an ordinary ring oscillator circuit which includes drivers for driving the clock signals for each of the stages. Other well-known clock circuits may be used. As can be seen in FIG. 2, the clock signals are complementary, that is, one clock is shifted by 180° from the other clock. There is no dead time between the clock signals.

In one embodiment, all the charge pump circuit stages and the clock circuit are fabricated on the same substrate (the same integrated circuit) as part of a flash memory. The potential at the output of the charge pump is used for erasing and programming of cells in the flash memory.

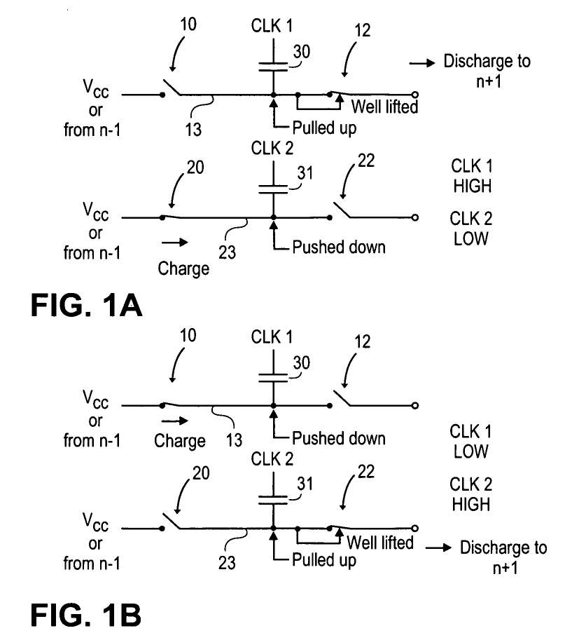

Referring to FIG. 1A, the circuit of FIG. 3 is shown with the input and output devices replaced with switches. The input and output devices operate as passgates, and consequently are represented as switches in FIG. 3. During a first period when the clock 1 signal is high and the clock 2 signal is low, the n-channel device 10 is not conducting or open and the p-channel device 12 is closed or conducting. In contrast, device 20 is conducting or closed and device 22 not conducting or open. Assuming that the nodes 13 and 23 are charged to V_{cc} (for the first stage of the charge pump circuit), the clock 1 signal during this first period of time, pulls up node 13, as node 13 discharges into the corresponding node of the next stage. Recall that in the next stage the input device in that stage will be conducting during this first period of time since its gate is connected to the clock 1 signal, and not to clock 2, as is the case for device 10 of FIG. 1A.

The output potential provided from the discharging node 13 is higher than V_{cc} because of the boot strapping occurring through the capacitor 30 resulting from the positive clock signal. Simultaneously, the well in which the device 12 is fabricated is also lifted, allowing the charge to be transferred from the node 13 with a relatively small voltage drop across the device 12. As may be seen in FIG. 3, p-channel device 14 is conducting coupling the well it shares with device 12 to the output potential of the stage. As this is occurring, since device 20 is closed and node 23 is pushed down through capacitor 31 by the clock 2 signal, node 23 charges. Note the charge remains on the node 23 since device 22 is open.

When the Clock 1 signal is low and the clock 2 signal is high, the output device 22 is closed and device 20 is open, as shown by FIG. 1B. The clock 2 signal pulls up node 23 and this node is discharged into the second node of the next stage. The well in which device 22 is formed is boosted to the output potential since device 24 of FIG. 3 is conducting. As this is occurring node 13 is being pushed down by the clock 1 signal, charging node 13.

As shown in FIGS. 1A and 1B, the first stage receives V_{cc} at the input devices, whereas the subsequent stages receive a charge from the prior stage shown as stage n−1. The output for the last stage, as mentioned, is typically connected to a common line to provide the higher output potential.

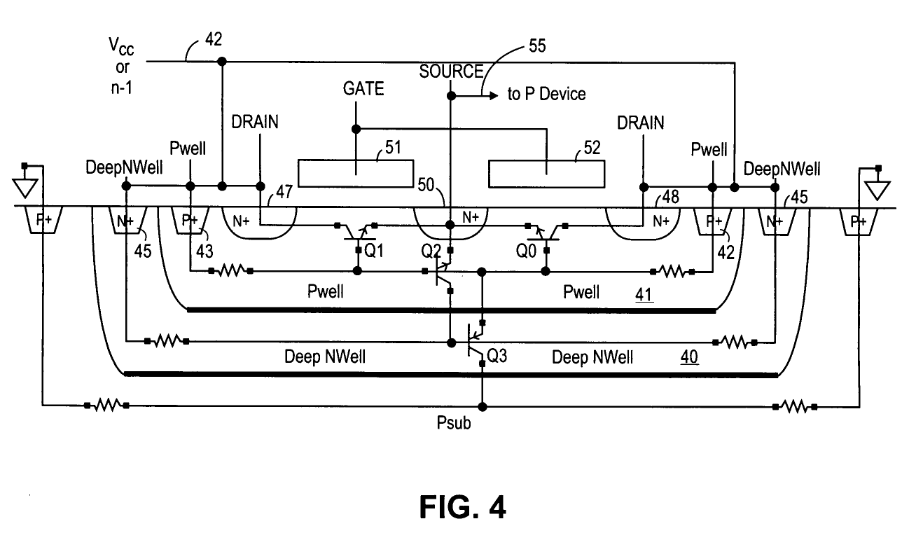

Referring now to FIG. 4, each n-channel device (each input device), in one embodiment, is fabricated in a deep n-well 40 formed in a p substrate. A p-well 41 is formed within the deep n-well 40. Two n-channel field-effect devices are formed within the p-well 41, sharing a common source region 50. One device comprises the n type regions 47 and 50 which define a channel region therebetween. A gate 51 is insulated from, and disposed above, this channel region. Similarly, the second n-channel device comprises the n type regions 48 and 50 with a channel region defined therebetween. A gate 52 is insulated from, and disposed above, this channel region. The gates 51 and 52 are connected together and driven by one of the clock signals. The source region 50 is driven by the other clock signal and is coupled (line 55) to the output p device. As shown in FIG. 4, the substrate is grounded, and the deep n-well 40 (through regions 45) and the p-well 41 (through regions 42 and 43) are coupled to the drain regions 47 and 48. The drain regions are connected, as shown by line 42, to V_{cc} for the first stage or to the output of another stage, again shown as stage n−1.

There are parasitic bipolar devices and related parasitic resistors formed within the n type device of FIG. 4 shown as Q0, Q1, Q2 and Q3. The lateral device Q0 is formed from the drain 48, p-well, and source 50; likewise, the lateral device Q1 is formed from the drain 47, p-well 41 and region 50. The device Q2 is formed by the deep n-well (the collector of device 40), the p-well 41 and the region 50 (the emitter of device Q2). There is also a device Q3, this pnp device is formed from wells 40 and 41 and the substrate. Q3 is always off.

The parasitic devices Q0, Q1 and Q2 assist in the charging of the charge node. These devices conduct when the drain regions are clocked 0.6V higher than the source 50 as occurs when the node is charged.

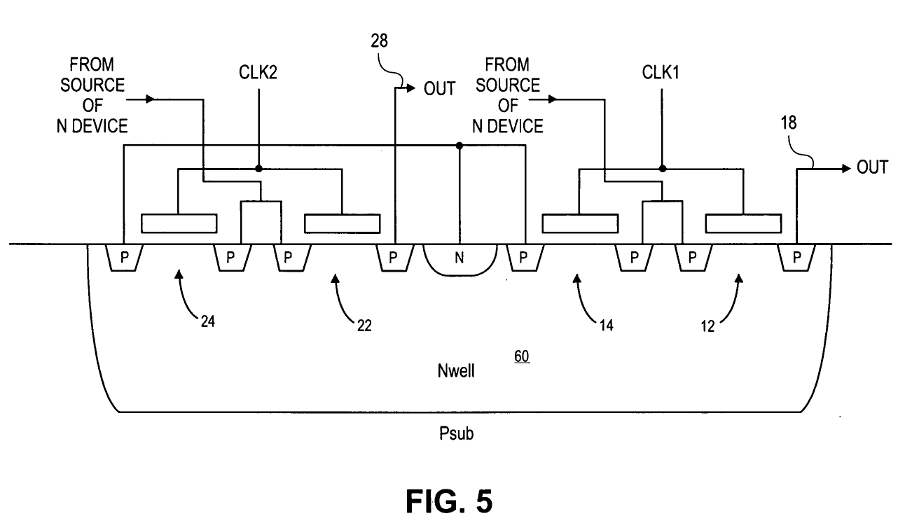

Referring to FIG. 5, in one embodiment the four p-channel devices of each stage are fabricated in a single n-well 60. The four p-channel devices of FIG. 3 are shown in FIG. 5; specifically devices 12 and 14 of one leg, and devices 22 and 24 of the other leg are found in well 60. The drains of transistors 12 and 22 are coupled to the output lines 18 and 28, respectively. Similarly, the sources of the devices 12 and 14 are coupled to the charge node in the first leg, and the sources of transistors 22 and 24 are coupled to the charging node in the second leg. While separate sources are shown for devices 12 and 14 and for device 22 and 24, they may share a common source region.

The well 60 is continually being switched to the node being discharged so that the n-well 60 is boosted. This boosting assures that the one of the two output p devices that are conducting, has its source terminal at the same potential as the well 60 and thereby substantially reducing any threshold voltage drop associated with the output devices.

The above charge pump circuit with its triple-well, tri-channel pipeline configuration, provides high power and high efficiency when compared with the prior art tri-channel gate enhancement charge pump circuits. The use of the triple-well, n type device with a p type device reduces the internal stress voltages down to below Vcc and avoids the use of the high voltage devices with low gin as pass gates. Note with the pipeline configuration, the charge nodes are continuously being either charged or discharged with no dead time. Among the advantages to this configuration is die size savings as well as reduction in power consumption.

Thus, an improved charge pump circuit has been described which utilizes a triple-well, tri-channel pipeline configuration.

1. A stage of a charge pump circuit comprising:
a first and a second node for alternately being charged and discharged, each node having an n-channel input device and a p-channel output device; and
a boosting circuit for alternately boosting a potential on the one of the first and second nodes being discharged;
wherein (a) each n-channel device is formed in a p-well disposed in an n-well, and comprises a common source region and a pair of drain regions on opposite sides of the source region defining a pair of channel regions, (b) a pair of gates is disposed above the channel region, the gates being coupled to the boosting circuit, (c) the source regions is coupled to one of the nodes, and (d) the drain regions, n-well, and p-well are coupled to one of the input devices.

2. The stage of claim 1, wherein the boosting circuit comprises first and second capacitors coupled to the first and second nodes, respectively, the capacitors receiving complementary clock signals.

3. The stage of claim 2, wherein the boosting circuit pulls down the node being charged.

4. The stage of claim 3, wherein the boosting circuit comprises a clock circuit providing the complementary clock signals.

5. (canceled)

6. (canceled)

7. A charge pump circuit including a first stage and a second stage each comprising the stages of claim 1, and
wherein the first node of the second stage is coupled to receive charge from the first node of the first stage, and wherein charge from the first node of the first stage is discharge while the first node of the second stage is charged.

8. A stage for a charge pump circuit comprising:
first and second n-channel input devices coupled to first and second circuit legs, respectively;
first and second p-channel output devices coupled to outputs of the first and second circuit legs, respectively, with a first node for storing charge disposed between the first input device and first output device, and a second node for storing charge disposed between the second input device and second output device; and
a clock circuit for turning on the first input device and second output device while turning off the second input device and first output device during a first period of time, and then, for turning on the second input device and first output device while turning off the first input device and second output device during a second period of time, the clock circuit boosting a potential on the first node during the second period of time, and boosting a potential on the second node during the first period of time;
wherein (a) each n-channel device is formed in a p-well disposed in an n-well, and comprises a common source region and a pair of drain regions on opposite sides of the source region defining a pair of channel regions, (b) a pair of gates are disposed above the channel region, the gates being coupled to the clock circuit through a capacitor, (c) the source regions is coupled to one of the nodes, and (d) the drain regions, n-well, and p-well are coupled to one of the input devices.

9. (canceled)

10. (canceled)

11. The stage of claim 8, wherein the p-channel devices are in a common n-well along with two other p-channel devices which alternately couple the n-well to the first and second nodes.

12.-20. (canceled)

21. A stage in a charge pump circuit having an input device and an output device where the input device comprises:
an n-channel device formed in a p-well disposed in an n-well, a source region with drain regions disposed on opposite sides defining a pair of channel regions therebetween, a gate disposed above each channel region, where the source region is coupled to a node in the stage charged from a stage input and where the drain regions, n-well and p-wells are coupled to the stage input.

22. The stage of claim 21, wherein each stage includes a p-channel device coupled between the node and a stage output.
